(19) United States
(12) Patent Application Publication
(10) Pub. No.: US 2025/0016164 A1
(43) Pub. Date: Jan. 9, 2025

(54) ACCESS REQUEST CAPTURING METHOD AND APPARATUS, AND COMPUTER DEVICE AND STORAGE MEDIUM

(71) Applicant: Suzhou MetaBrain Intelligent Technology Co., Ltd., Suzhou (CN)

(72) Inventor: Zhiwei Wei, Suzhou (CN)

(21) Appl. No.: 18/564,559

(22) PCT Filed: Jan. 26, 2022
(86) PCT No.: PCT/CN2022/074061

§ 371 Date: Jul. 25, 2024

(30) Foreign Application Priority Data
Sep. 26, 2021 (CN) 202111126065.7

(51) Int. Cl. H04L 9/40

(52) U.S. Cl. CPC H04L 63/102; H04L 63/108; H04L 63/1466

(57) ABSTRACT

An access request capturing method comprises: upon receiving an initial access request from a current user, returning session response information, wherein the session response information comprises a session control identifier and auxiliary authentication data that are stored at different locations; receiving a current non-initial access request from the current user; and when the current non-initial access request carries the session control identifier and does not carry the auxiliary authentication data, capturing the current non-initial access request.

### CROSS-REFERENCE OF RELATED APPLICATIONS

This application is the U.S. National stage of PCT/CN2022/074061 filed on Jan. 26, 2022, which claims priority to Chinese patent application No. CN202111126065.7, filed with the China National Intellectual Property Administration on Sep. 26, 2021 and entitled “ACCESS REQUEST CAPTURING METHOD AND APPARATUS, AND COMPUTER DEVICE AND STORAGE MEDIUM”, the disclosure of which is hereby incorporated by reference in its entirety.

### TECHNICAL FIELD

The present application relates to an access request capturing method and apparatus, and a computer device and a storage medium.

### BACKGROUND

Since the web (Global Wide Area Network) has become the mainstream network and application technology, the security of web servers has been the focus of attention in the industry. Cyber attacks such as website defacement and virus spread in various places have caused significant losses to users and Internet companies.

At present, web protection software is mostly a combination of data security software and firewall products, which makes it difficult to accurately identify whether a certain access behavior is a normal access of a real user. This kind of software typically determines an access behavior on the basis of the process and service, but it performs detection late and therefore cannot effectively block virus programs from infiltrating the host. This leaves a window of opportunity that can be exploited by other malicious operations.

### SUMMARY OF THE INVENTION

Provided in the embodiments of the present application is an access request capturing method, comprising:
upon receiving an initial access request from a current user, returning session response information, wherein the session response information comprises a session control identifier and auxiliary authentication data that are stored at different locations;
receiving a current non-initial access request from the current user; and
when the current non-initial access request carries the session control identifier and does not carry the auxiliary authentication data, capturing the current non-initial access request.

In one embodiment, the access request capturing method further comprises:
when the current non-initial access request carries the session control identifier and carries the auxiliary authentication data, judging whether an API called by the current non-initial access request is consistent with a preset trap API; and
when the API called by the current non-initial access request is consistent with the preset trap API, capturing the current non-initial access request.

In one embodiment, the access request capturing method further comprises:
when the current non-initial access request carries the session control identifier and carries the auxiliary authentication data, judging whether the time corresponding to a time stamp carried by the current non-initial access request has been shifted previously; and
when the time corresponding to the time stamp carried by the current non-initial access request has been shifted previously, capturing the current non-initial access request.

In one embodiment, the access request capturing method further comprises:
when the current non-initial access request carries the session control identifier and carries the auxiliary authentication data, judging whether request data carried by the current non-initial access request is consistent with preset trap data; and
when the request data carried by the current non-initial access request is consistent with the preset trap data, capturing the current non-initial access request.

In one embodiment, the access request capturing method further comprises:
when the current non-initial access request carries the session control identifier and carries the auxiliary authentication data, judging whether the current non-initial access request instructs to call an authentication interface of a preset false database; and
when the current non-initial access request instructs to call the authentication interface of the preset false database, capturing the current non-initial access request.

In one embodiment, the access request capturing method further comprises:
when the current non-initial access request carries the session control identifier and carries the auxiliary authentication data, executing the following judgment steps according to a preset order of execution:
judging whether an API called by the current non-initial access request is consistent with a preset trap API,
judging whether the time corresponding to a time stamp carried by the current non-initial access request has been shifted previously,
judging whether request data carried by the current non-initial access request is consistent with preset trap data, and
judging whether the current non-initial access request instructs to call an authentication interface of a preset false database;
when the result of any one of the above judgment steps is yes, stopping executing the subsequent judgment steps, and capturing the current non-initial access request; and
when capturing the current non-initial access request, executing a malicious request handling operation.

In one embodiment, the step of executing a malicious request handling operation further comprises:
determining a malicious access level corresponding to the current non-initial access request, and updating malicious access data corresponding to the current user, wherein the malicious access data is used for recording numbers of malicious access attempts corresponding to different malicious access levels; and
when the number of malicious access attempts corresponding to any one of the malicious access levels reaches a corresponding preset threshold value, executing an access restriction operation.

Further provided in the embodiments of the present application is an access request capturing apparatus, comprising:
a response module, which is configured to return session response information upon receiving an initial access request from a current user, wherein the session response information comprises a session control identifier and auxiliary authentication data that are stored at different locations;
a subsequent request receiving module, which is configured to receive a current non-initial access request from the current user; and
a capturing module, which is configured to capture the current non-initial access request when the current non-initial access request carries the session control identifier and does not carry the auxiliary authentication data.

Further provided in the embodiments of the present application is a computer device, which comprises a memory and one or more processors, wherein the memory has computer-readable instructions stored therein, and the computer-readable instructions, when executed by the one or more processors, cause the one or more processors to execute the steps of the access request capturing method in any one of the foregoing embodiments.

Further provided in the embodiments of the present application is one or more non-transitory computer-readable storage media, having computer-readable instructions stored therein, wherein the computer-readable instructions, when executed by one or more processors, cause the one or more processors to execute the steps of the access request capturing method in any one of the foregoing embodiments.

### BRIEF DESCRIPTION OF THE DRAWINGS

FIG. 1 is an application environment diagram of an access request capturing method according to one or more embodiments;

FIG. 2 is a schematic process diagram of an access request capturing method according to one or more embodiments;

FIG. 3 is a structural block diagram of an access request capturing apparatus according to one or more embodiments; and

FIG. 4 is an internal structure diagram of a computer device according to one or more embodiments.

### DETAILED DESCRIPTION

In order to make the technical solutions and advantages of the embodiments of the present application clearer, the present application will be described hereinafter in further detail with reference to the accompanying drawings and embodiments. It should be understood that the specific embodiments described herein are for the purpose of explaining the present application only, and are not intended to be limiting.

An access request capturing method provided in the embodiments of the present application can be applied to the application environment as shown in FIG. 1. Wherein, a server 101 may communicate with a terminal 102 over a network. The server 101 may receive an initial access request from the terminal 102 and return session response information. Wherein, the server 101 may be implemented as an independent server or a server cluster composed of a plurality of servers, and the terminal 102 may be, but is not limited to, various personal computers, notebook computers, smart phones, tablet computers and portable wearable devices.

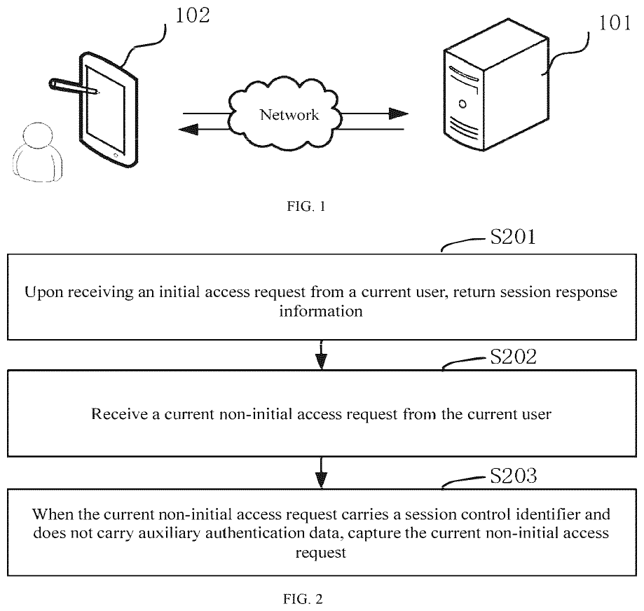

In some embodiments, as shown in FIG. 2, an access request capturing method is provided, which, illustrated by an example of applying the method to the server 101 in FIG. 1, comprises the following steps:
step S201, upon receiving an initial access request from a current user, returning session response information, wherein the session response information comprises a session control identifier and auxiliary authentication data that are stored at different locations;
step S202, receiving a current non-initial access request from the current user; and
step S203, when the current non-initial access request carries the session control identifier and does not carry the auxiliary authentication data, capturing the current non-initial access request.

According to the access request capturing method provided in the embodiments of the present application, upon receiving an initial access request from the terminal 102, the server 101 creates a session control identifier and auxiliary authentication data that correspond to a current user, and sets the session control identifier and the auxiliary authentication data at different locations in the session response information, making it difficult for most means of network eavesdropping to acquire complete authentication information required by the server 101. When a current non-initial access request is received subsequently, the content of the current non-initial access request is comprehensively authenticated according to the session control identifier and the auxiliary authentication data, which improves the security of network communication. Even if the session control identifier is compromised or cracked, a cyber attacker who initiates session control identifier authentication in the conventional way will have difficulty passing test and getting access to website resources due to the failure to provide the auxiliary authentication data.

About a current user. The current user in step S201 generally refers to a user who is visiting a website at present. For the server 101, if a plurality of access requests received in one session are from the same user account, senders of these access requests can be regarded as the same current user.

About an initial access request. An initial access request of a current user refers to an initial access request from the current user in a session. In the conventional technology, a web server will create, according to an initial access request of a user in a session process, a session control identifier for the session process and the user, and return the session control identifier to a client where the user is located. The user only needs to log in to a website once, and in this session process, the user can continuously access, by virtue of the session control identifier, website resources that can be accessed only after login. Unlike the conventional technology, in the embodiments of the present application, the session response information returned by the server 101 to the terminal 102 includes auxiliary authentication data in addition to a session control identifier, which enables the server 101 to subsequently authenticate each access request in a different way.

In some embodiments, the session control identifier in the session response information is a session ID (session control identification number). In general, after receiving an initial access request of a current user, the server 101 will create a session (session control) object for the current user. Each session object has a unique session ID, thus ensuring that the current user uniquely corresponds to the session object thereof. Typically, a session object may be a block of memory created by the server 101.

In general, when a current user accesses website resources using a browser that supports the use of cookie (web cookie, a web technology) data, a session ID will be set somewhere in the cookie data. The session ID may be delivered between the server 101 and the terminal 102 by means of the delivery of the cookie data. Of course, the session ID may be delivered using other techniques, such as URL (Uniform Resource Locator) rewriting, which will not be explained herein. Most cyber attackers will utilize a mechanism for session ID delivery and authentication to eavesdrop on or violently break a session ID, for example, obtaining a session ID by acquiring cookie data. At this time, after the current user has logged in, a cyber attacker may write into an access request a session ID that is obtained by an illegal means, and send the access request to the server 101 in order to access website resources. In the embodiments of the present application, the session ID and the auxiliary authentication data are set at different locations in the session response information, for example, the session ID is set in cookie data, and the auxiliary authentication data is set outside the text location where the cookie data is located, making it difficult for a cyber attacker to determine which authentication data should be carried by a correct access request.

In some embodiments, the auxiliary authentication data may be set at different locations in a response header of the session response information. In general, the session response information may include a response line, a response header and a response body, wherein the response line may include a communication protocol version, a status code and other data, the response header may include Server (Server type), Date (time), Content-Type (file type), Cache-Control (cache control), Set-cookie (set cookie) and other fields, and the response body may include various resource data that the current user wants to access. It can be seen that the response header may have a plurality of different fields, and the auxiliary authentication data may be field values corresponding to a plurality of fields. The response header may even include new fields written by the server 101, the field values of which are part of the auxiliary authentication data. It can be seen that the auxiliary authentication data may be a field value of one field or field values of a plurality of fields, and the auxiliary authentication data may even be a character with a specified number of digits in the field value of one field. Thus, the specific format of the auxiliary authentication data can be varied.

About a non-initial access request. In order to distinguish a subsequent access request from an initial access request, the concept of a non-initial access request is introduced. A non-initial access request refers to, after an initial access request from a current user is received, at least part of other access requests received by the server 101 from the current user. Typically, after an initial access request, an access request that is received for requesting the access to website resources, requesting the change of resource attributes, or requesting the change of permissions, etc. can be regarded as a non-initial access request. Some requests that may be considered not to have cyber security risks, such as a request regarding the end of a session, may not be regarded as non-initial access requests.

In some cases, the account number corresponding to the current user may be stolen, and the terminal 102 corresponding to the current user may be controlled by a cyber attacker, so that the server 101 will receive access requests that are sent in the name of the current user but are actually rewritten by the cyber attacker. Such access requests are also regarded as non-initial access requests of the current user. Of course, the possibility of an initial access request being also designed and issued by a cyber attacker cannot be ruled out, and at this time, the current user may refer to the user of the terminal 102 controlled by the cyber attacker. Anyhow, the number of non-initial access requests may be one or more. The current non-initial access request in step S202 refers to a non-initial access request currently received by the server 101.

About the capture of a current non-initial access request. It is stated in step S203 that, when a current non-initial access request carries a session control identifier and does not carry auxiliary authentication data, the current non-initial access request is captured. This step indicates that the server 101 identifies that a current non-initial access request is a malicious request and captures the malicious request, such that the server 101 can avoid suffering from further cyber attacks. Typically, after a malicious request is captured, a response can be made by means of not responding, or providing low-value, invalid or false data, or returning warning information, etc., which will not be explained herein.

In some embodiments, step S201 may comprise: receiving an initial access request of a current user, and returning session response information. Step S203 may comprise: in response to a current non-initial access request carrying a session control identifier and not carrying auxiliary authentication data, capturing the current non-initial access request.

The above mainly describes the ideas and important concepts that are involved in step S201, step S202 and step S203.

In some embodiments, the access request capturing method further comprises:
when the current non-initial access request carries the session control identifier and carries the auxiliary authentication data, judging whether an API (Application Programming Interface) called by the current non-initial access request is consistent with a preset trap API; and
if yes, capturing the current non-initial access request.

Specifically, the access request capturing method may comprise:
in response to the current non-initial access request carrying the session control identifier and carrying the auxiliary authentication data, judging whether an API called by the current non-initial access request is consistent with a preset trap API; and in response to the API called by the current non-initial access request being consistent with the preset trap API, capturing the current non-initial access request.

The server 101 may define a manner in which some core APIs are called. In the conventional technology, regular API fields comprise delete, update, get, push, etc. In general, an access request sent from a client to a server will carry an API field and request the server to perform a corresponding operation, for example, the operation corresponding to delete is “to delete data”. Typically, cyber attackers will send a non-initial access request according to the common usage of these API types. However, the server 101 may change the functions corresponding to some generic APIs, or cancel the functions of some APIs, so that the manner in which the APIs are called changes. At this time, it is difficult for cyber attackers to know the manner in which the core APIs of the server 101 are called. For example, the server 101 is requested to execute an operation of “deleting data”. The server 101 defines the API field corresponding to the operation as shanchu instead of delete. On the contrary, the server 101 defines an API corresponding to the delete field as a trap API. If a current non-initial access request received by the server 101 has a delete field, it can be considered that the current non-initial access request carries an undesirable API field, and the API carried by the request is consistent with the trap API. At this time, the current non-initial access request may be captured.

Specifically, the server 101 may call a core API in a hidden manner and set a trap API using the REST (Representational State Transfer) technology.

When the server judges that an API called by a current non-initial access request is consistent with a preset trap API, capturing is not performed in this link. The server 101 may be provided with one or more trap APIs depending on actual requirements.

In some embodiments, the access request capturing method further comprises:
when the current non-initial access request carries the session control identifier and carries the auxiliary authentication data, judging whether the time corresponding to a time stamp carried by the current non-initial access request has been shifted previously; and
if yes, capturing the current non-initial access request.

Specifically, the access request capturing method may comprise:
in response to the current non-initial access request carrying the session control identifier and carrying the auxiliary authentication data, judging whether the time corresponding to a time stamp carried by the current non-initial access request has been shifted previously; and in response to the time corresponding to the time stamp carried by the current non-initial access request having been shifted previously, capturing the current non-initial access request.

In general, a cyber attacker may send to the server 101 again an access request that has been received by the server 101, in an attempt to deceive the server 101. This means is mainly used in the identity authentication process to destroy the correctness of authentication. This replay attack can be identified by means of a time stamp verification mechanism. Specifically, the server 101 may store time stamps carried by an initial access request and a non-initial access request that are sent from the current user, and each time stores a time stamp carried by the latest access request sent from the current user. At the next moment, when a current non-initial access request is received, a time stamp carried by the current non-initial access request may be compared with a stored time stamp carried by a last sent access request. If the time corresponding to the time stamp carried by the current non-initial access request is the same as or earlier than the time corresponding to the time stamp carried by the last sent access request, it is determined that the time corresponding to the time stamp carried by the current non-initial access request has been shifted previously, the current non-initial access request is regarded as a malicious request, and the current non-initial access request is captured. If the time corresponding to the time stamp carried by the current non-initial access request has not been shifted previously, capturing is not performed in this link.

In some embodiments, the access request capturing method further comprises:
when the current non-initial access request carries the session control identifier and carries the auxiliary authentication data, judging whether request data carried by the current non-initial access request is consistent with preset trap data; and
if yes, capturing the current non-initial access request.

Specifically, the access request capturing method may comprise:
determining that the current non-initial access request carries the session control identifier and carries the auxiliary authentication data; judging whether request data carried by the current non-initial access request is consistent with preset trap data; and in response to the request data carried by the current non-initial access request being consistent with the preset trap data, capturing the current non-initial access request.

As mentioned earlier, session response information may comprise a response line, a response header and a response body. Similarly, a current non-initial access request may also comprise a request line, a request header and a request body. In general, request data carried by a current non-initial access request is usually located in the request body. Judging whether request data carried by a current non-initial access request is consistent with preset trap data may be, specifically, judging whether a username in the request data is consistent with a username in the preset trap data, and of course, may be judging whether a character at another location in the request data is consistent with a preset character in the trap data, which will not be explained herein in further detail.

Taking username comparison as an example, trap data may be preset as username=test and password=123456. In fact, test does not exist in the username of a normally authenticated user. At this time, if a received current non-initial access request carries username=test, the current non-initial access request can be regarded as a request initiated by an abnormal means, and the capture of the current non-initial access request may be executed.

If the request data carried by the current non-initial access request is inconsistent with the preset trap data, capturing is not performed in this link.

In some embodiments, the access request capturing method further comprises:
when the current non-initial access request carries the session control identifier and carries the auxiliary authentication data, judging whether the current non-initial access request instructs to call an authentication interface of a preset false database; and
if yes, capturing the current non-initial access request.

Specifically, the access request capturing method may comprise:
in response to the current non-initial access request carrying the session control identifier and carrying the auxiliary authentication data, judging whether the current non-initial access request instructs to call an authentication interface of a preset false database; and in response to the current non-initial access request instructing to call the authentication interface of the preset false database, capturing the current non-initial access request.

The server 101 may also actively give out the login port, login account number and login password of the false database, so that cyber attackers can be informed of same from multiple pieces of session response information returned by the server 101 or by other means. The authentication interface of the false database is preset, and the data in the false database may be worthless. At this time, if the current non-initial access request carries information about the login port, login account number and login password, the current non-initial access request instructs to call the authentication interface of the false database, in an attempt to illegally access the database or to perform an illegal operation, and the current non-initial-time access request is captured. This means can help to judge whether the current user's session is abnormal or not. If the current non-initial access request does not instruct to call the authentication interface of the preset false database, capturing is not executed.

In some embodiments, the access request capturing method further comprises:
when the current non-initial access request carries the session control identifier and carries the auxiliary authentication data, executing the following judgment steps according to a preset order of execution:
judging whether an API called by the current non-initial access request is consistent with a preset trap API,
judging whether the time corresponding to a time stamp carried by the current non-initial access request has been shifted previously,
judging whether request data carried by the current non-initial access request is consistent with preset trap data, and
judging whether the current non-initial access request instructs to call an authentication interface of a preset false database;
when the result of any one of the above judgment steps is yes, stopping executing the subsequent judgment steps, capturing the current non-initial access request, and executing a malicious request handling operation.

Specifically, the access request capturing method may comprise:
in response to the current non-initial access request carrying the session control identifier and carrying the auxiliary authentication data, executing the following judgment steps according to a preset order of execution:
judging whether an API called by the current non-initial access request is consistent with a preset trap API,
judging whether the time corresponding to a time stamp carried by the current non-initial access request has been shifted previously,
judging whether request data carried by the current non-initial access request is consistent with preset trap data, and
judging whether the current non-initial access request instructs to call an authentication interface of a preset false database; and
in response to the result of any one of the above judgment steps being yes, stopping executing the subsequent judgment steps, capturing the current non-initial access request, and executing a malicious request handling operation.

For an access request of the current user, besides confirming whether the access request carries both a session control identifier and auxiliary authentication data, a plurality of judgment steps are set, which is equivalent to setting a plurality of checkpoints for identifying a malicious request. Thus, the limitations of the existing trapping technology are compensated, and trap rooms are scattered in a three-dimensional manner, so as to better act on the entire web system.

It should be noted that there are four judgment steps mentioned above, which are respectively:
(1) judging whether an API called by a current non-initial access request is consistent with a preset trap API;
(2) judging whether the time corresponding to a time stamp carried by the current non-initial access request has been shifted previously;
(3) judging whether request data carried by the current non-initial access request is consistent with preset trap data; and
(4) judging whether the current non-initial access request instructs to call an authentication interface of a preset false database.

Although there are four judgment steps, it is not necessary to execute all the four judgment steps for a current non-initial access request. If the judgment result obtained in one of the judgment steps is “yes”, it means that the current non-initial access request is a malicious request. At this time, the current non-initial access request is captured and a malicious request handling operation is executed, and the other unexecuted judgment steps are no longer executed. This saves the server 101 from data processing and improves the efficiency of malicious request identification.

The preset order of execution of the judgment steps mentioned above may be adjusted according to actual requirements.

In some embodiments, an access request capturing method comprises the following steps:
upon receiving an initial access request from a current user, returning session response information;
receiving a current non-initial access request from the current user;
when the current non-initial access request carries a session control identifier and does not carry auxiliary authentication data, capturing the current non-initial access request;
when the current non-initial access request carries the session control identifier and carries the auxiliary authentication data, judging whether an API called by the current non-initial access request is consistent with a preset trap API, and if yes, capturing the current non-initial access request, and executing a malicious request handling operation,
if no, judging whether the time corresponding to a time stamp carried by the current non-initial access request has been shifted previously, and if yes, capturing the current non-initial access request, and executing a malicious request handling operation,
if no, judging whether request data carried by the current non-initial access request is consistent with preset trap data, and if yes, capturing the current non-initial access request, and executing a malicious request handling operation; and
if no, judging whether the current non-initial access request instructs to call an authentication interface of a preset false database, if yes, capturing the current non-initial access request, and executing a malicious request handling operation, and if no, returning corresponding response information according to the current non-initial access request.

In some embodiments, the step of executing a malicious request handling operation further comprises:
determining a malicious access level corresponding to the current non-initial access request, and updating malicious access data corresponding to the current user, wherein the malicious access data is used for recording numbers of malicious access attempts corresponding to different malicious access levels; and
when the number of malicious access attempts corresponding to any one of the malicious access levels reaches a corresponding preset threshold value, executing an access restriction operation.

The aforementioned malicious access data can be expressed in the form of a table. In some more specific cases, the number of malicious access levels may be set to three, and if a current non-initial access request is captured, the current non-initial access request may be classified as one of the following three malicious access requests:
(1) a first-level malicious access request: the time corresponding to a time stamp carried by the current non-initial access request has been shifted previously;
(2) a second-level malicious access request: an API called by the current non-initial access request is consistent with a preset trap API, or request data carried by the current non-initial access request is consistent with preset trap data, or the current non-initial access request instructs to call an authentication interface of a preset false database; and
(3) a third-level malicious access request: the current non-initial access request carries a session control identifier and does not carry auxiliary authentication data.

Each category of access requests corresponds to one malicious access level. When the number of malicious access attempts corresponding to any one of the malicious access levels reaches a corresponding preset threshold value, an access restriction operation is executed. In general, receiving a new malicious access request of a current user may be regarded as adding one to the number of malicious access attempts of the current user.

One or more preset threshold values may be set corresponding to each malicious access level, which is equivalent to that one or more preset threshold values may be set corresponding to the number of occurrences of each malicious access request. When a preset threshold value is reached, an access restriction operation is executed. The manner for an access restriction operation comprises logging out of an account or blocking an IP (Internet Protocol) address, etc, which will not explained herein in further detail.

For example, with regard to first-level malicious access requests, when the number of first-level malicious access requests of the current user is 1, the server 101 returns warning information; when the number of first-level malicious access requests of the current user is 10-50, the server 101 executes a logout operation; and when the number of first-level malicious access requests of the current user is greater than 50, the server 101 executes an operation of blocking the IP address of the current user.

With regard to second-level malicious access requests, when the number of second-level malicious access requests of the current user is 1, the server 101 executes a logout operation; and when the number of second-level malicious access requests of the current user is greater than 10, the server 101 executes an operation of blocking the IP address of the current user.

With regard to third-level malicious access requests, when the number of third-level malicious access requests of the current user is 1, the server 101 executes an operation of blocking the IP address of the current user.

In addition, the server 101 may back up malicious access data of different users, count the numbers of malicious access attempts corresponding to different malicious access levels by acquiring malicious access data of a plurality of users, and determine an order of execution of the aforementioned four judgment steps according to a counting result. For example, among a first-level malicious access request, a second-level malicious access request and a third-level malicious access request, when the total number of malicious access attempts corresponding to the first-level malicious access request is the largest, the judgment step for judging the first-level malicious access request is set to be executed first; and when the total number of malicious access attempts corresponding to the second-level malicious access request is relatively small, the judgment steps for judging the second-level malicious access request are set to be executed later. There are multiple judgment steps in the second-level malicious access request, and the order of execution of the different judgment steps in the second-level malicious access request may also be determined according to a counting result and by using the corresponding number of malicious access requests as a sorting basis.

In addition, dynamic counting periods may also be set, and the order of execution of the four judgment steps may be updated according to a counting result obtained in each dynamic counting period. For example, the four quarters of a year may be set as four dynamic counting periods, and the order of execution of the four judgment steps may be updated according to a counting result of each quarter.

It should be understood that although the steps in the flowchart of FIG. 2 are shown in order as indicated by the arrows, these steps are not necessarily executed in order as indicated by the arrows. Furthermore, at least a portion of the steps in FIG. 2 may include a plurality of sub-steps or stages. These sub-steps or stages are not necessarily executed at the same moment, but may be executed at different moments. These sub-steps or stages are not necessarily executed in order, but may be executed in turn or alternately with other steps or at least a portion of sub-steps or stages of the other steps.

In addition, the other steps mentioned in the embodiments of the present application, unless expressly stated herein, are not strictly limited in the order in which these steps may be executed, and these steps may be executed in other orders.

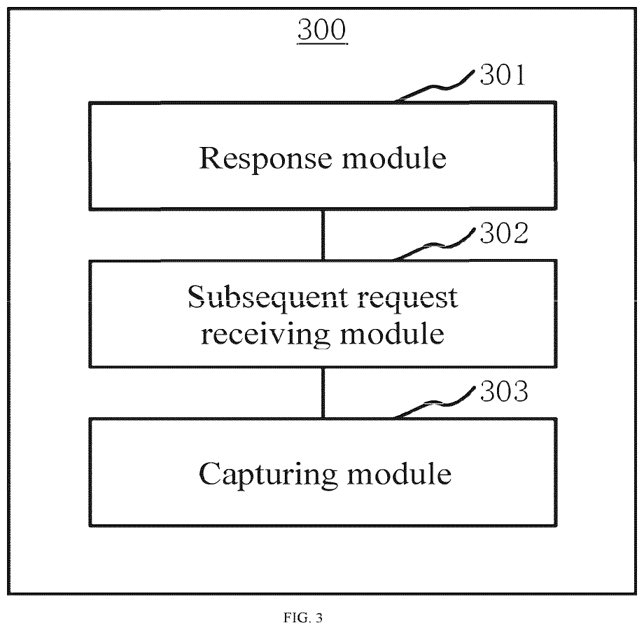

In some embodiments, as shown in FIG. 3, an access request capturing apparatus 300 is provided, comprising:
a response module 301, which is configured to return session response information upon receiving an initial access request from a current user, wherein the session response information comprises a session control identifier and auxiliary authentication data that are stored at different locations;
a subsequent request receiving module 302, which is configured to receive a current non-initial access request from the current user; and
a capturing module 303, which is configured to capture the current non-initial access request when the current non-initial access request carries the session control identifier and does not carry the auxiliary authentication data.

In some embodiments, the response module 301 is configured to receive an initial access request from a current user and return session response information; and the capturing module 303 is configured to capture a current non-initial access request in response to the current non-initial access request carrying a session control identifier and not carrying auxiliary authentication data.

In some embodiments, the access request capturing apparatus 300 further comprises an API trapping module (not shown), which is configured to judge, when the current non-initial access request carries the session control identifier and carries the auxiliary authentication data, whether an API called by the current non-initial access request is consistent with a preset trap API, and if yes, to capture the current non-initial access request.

In some embodiments, the API trapping module is configured to judge, in response to the current non-initial access request carrying the session control identifier and carrying the auxiliary authentication data, whether an API called by the current non-initial access request is consistent with a preset trap API; and in response to the API called by the current non-initial access request being consistent with the preset trap API, to capture the current non-initial access request.

In some embodiments, the access request capturing apparatus 300 further comprises a replay trapping module (not shown), which is configured to judge, when the current non-initial access request carries the session control identifier and carries the auxiliary authentication data, whether the time corresponding to a time stamp carried by the current non-initial access request has been shifted previously, and if yes, to capture the current non-initial access request.

In some embodiments, the replay trapping module is configured to judge, in response to the current non-initial access request carrying the session control identifier and carrying the auxiliary authentication data, whether the time corresponding to a time stamp carried by the current non-initial access request has been shifted previously; and in response to the time corresponding to the time stamp carried by the current non-initial access request having been shifted previously, to capture the current non-initial access request.

In some embodiments, the access request capturing apparatus 300 further comprises a data trapping module (not shown), which is configured to judge, when the current non-initial access request carries the session control identifier and carries the auxiliary authentication data, whether request data carried by the current non-initial access request is consistent with preset trap data, and if yes, to capture the current non-initial access request.

In some embodiments, the data trapping module is configured to judge, in response to the current non-initial access request carrying the session control identifier and carrying the auxiliary authentication data, whether request data carried by the current non-initial access request is consistent with preset trap data; and in response to the request data carried by the current non-initial access request being consistent with the preset trap data, to capture the current non-initial access request.

In some embodiments, the access request capturing apparatus 300 further comprises a database trapping module (not shown), which is configured to judge, when the current non-initial access request carries the session control identifier and carries the auxiliary authentication data, whether the current non-initial access request instructs to call an authentication interface of a preset false database, and if yes, to capture the current non-initial access request.

In some embodiments, the database trapping module is configured to judge, in response to the current non-initial access request carrying the session control identifier and carrying the auxiliary authentication data, whether the current non-initial access request instructs to call an authentication interface of a preset false database; and in response to the current non-initial access request instructing to call the authentication interface of the preset false database, to capture the current non-initial access request.

In some embodiments, the access request capturing apparatus 300 further comprises:
a judgment step execution control module (not shown), which is configured to execute, when the current non-initial access request carries the session control identifier and carries the auxiliary authentication data, the following judgment steps according to a preset order of execution:
judging whether an API called by the current non-initial access request is consistent with a preset trap API,
judging whether the time corresponding to a time stamp carried by the current non-initial access request has been shifted previously,
judging whether request data carried by the current non-initial access request is consistent with preset trap data, and
judging whether the current non-initial access request instructs to call an authentication interface of a preset false database;
a judgment result processing module (not shown), which is configured to stop, when the result of any one of the above judgment steps is yes, executing the subsequent judgment steps, and to capture the current non-initial access request; and
a malicious request handling module (not shown), which is configured to execute a malicious request handling operation when capturing the current non-initial access request.

In some embodiments, the judgment step execution control module is configured to execute, in response to the current non-initial access request carrying the session control identifier and carrying the auxiliary authentication data, the following judgment steps according to a preset order of execution:
judging whether an API called by the current non-initial access request is consistent with a preset trap API,
judging whether the time corresponding to a time stamp carried by the current non-initial access request has been shifted previously,
judging whether request data carried by the current non-initial access request is consistent with preset trap data, and
judging whether the current non-initial access request instructs to call an authentication interface of a preset false database.

The judgment result processing module is configured to stop, in response to the result of any one of the above judgment steps being yes, executing the subsequent judgment steps, and to capture the current non-initial access request.

In some embodiments, the malicious request handling module comprises:
a malicious access level determining unit, which is configured to determine a malicious access level corresponding to the current non-initial access request, and to update malicious access data corresponding to the current user, wherein the malicious access data is used for recording numbers of malicious access attempts corresponding to different malicious access levels; and
an access restriction operation unit, which is configured to execute an access restriction operation when the number of malicious access attempts corresponding to any one of the malicious access levels reaches a corresponding preset threshold value.

In some embodiments, the access restriction operation unit is configured to execute an access restriction operation in response to the number of malicious access attempts corresponding to any one of the malicious access levels reaching a corresponding preset threshold value.

The specific definitions to the access request capturing apparatus may be found in the definitions to the access request capturing method described above and will not be repeated here. The modules in the access request capturing apparatus may be implemented in whole or in part by software, hardware and combinations thereof. Each of the above-mentioned modules may be embedded, in the form of hardware, in or independent of a processor in a computer device and may also be stored, in the form of software, in a memory in the computer device, such that the processor can conveniently call the modules to execute operations corresponding to the modules.

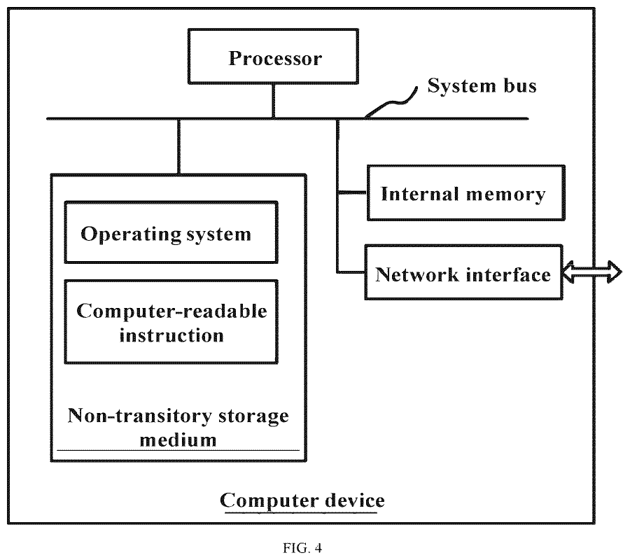

In some embodiments, provided in the embodiments of the present application is a computer device which may be a server, the internal structure diagram of which may be as shown in FIG. 4. The computer device comprises a processor, a memory and a network interface, which are connected by means of a system bus. Wherein, the processor of the computer device is configured to provide computing and control capabilities. The memory of the computer device comprises a non-transitory storage medium and an internal memory. The non-transitory storage medium has an operating system, computer-readable instructions, and a database stored therein. The internal memory provides an environment for the operation of the operating system and the computer-readable instructions in the non-transitory storage medium. A network interface of the computer device is configured to communicate with an external terminal by means of a network connection. The computer-readable instructions, when executed by the processor, implement an access request capturing method.

It will be understood by a person skilled in the art that the structure illustrated in FIG. 4 is only a block diagram of part of the structure related to the solution of the present application and does not constitute a limitation on a computer device to which the solution of the present application is applied, and that a specific computer device may comprise more or fewer components than shown in the figure, or may be a combination of certain components, or may have a different component arrangement.

In some embodiments, a computer device provided in the embodiments of the present application comprises a memory and one or more processors, wherein the memory has computer-readable instructions stored therein, and the computer-readable instructions, when executed by the one or more processors, cause the one or more processors to execute the steps of the access request capturing method in any one of the foregoing embodiments.

In some embodiments, provided in the embodiments of the present application is one or more non-transitory computer-readable storage media, having computer-readable instructions stored therein, wherein the computer-readable instructions, when executed by one or more processors, cause the one or more processors to execute the steps of the access request capturing method in any one of the foregoing embodiments.

It will be understood by a person of ordinary skill in the art that all or part of the processes of implementing the methods of the above-described embodiments can be accomplished by instructing related hardware by means of computer-readable instructions stored in a non-transitory computer-readable storage medium, and that the computer-readable instructions, when executed, may comprise processes such as the processes of the above-described embodiments regarding the methods. Wherein, any reference to a memory, storage, database, or other medium provided by the embodiments of the present application and used in various embodiments may comprise a non-transitory memory and/or a transitory memory. The non-transitory memory may comprise a read-only memory (ROM), a programmable ROM (PROM), an electrically programmable ROM (EPROM), an electrically erasable programmable ROM (EEPROM) or a flash memory. The transitory memory may comprise a random access memory (RAM) or an external cache memory. As an illustration rather than a limitation, an RAM is available in various forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a memory bus (Rambus) direct RAM (RDRAM), a direct Rambus dynamic RAM (DRDRAM), an Rambus dynamic RAM (RDRAM), etc.

The technical features of the above embodiments may be arbitrarily combined, and all possible combinations of the technical features of the above embodiments have not been described in order to make the description concise. However, as long as there is no contradiction in the combinations of these technical features, they shall be considered to fall within the scope recited in this specification.

The above embodiments express only several embodiments of the present application, which are described in a more specific and detailed manner, but are not to be construed as a limitation on the patent scope of the present invention. It should be noted that a person of ordinary skill in the art may, without departing from the concept of the present application, make a number of variations and improvements, all of which shall fall within the scope of protection of the present application. Therefore, the scope of protection of the patent of the present application shall be subject to the attached claims.

1. An access request capturing method, wherein the method comprises:
upon receiving an initial access request from a current user, returning session response information, wherein the session response information comprises a session control identifier and auxiliary authentication data that are stored at different locations;
receiving a current non-initial access request from the current user; and
when the current non-initial access request carries the session control identifier and does not carry the auxiliary authentication data, capturing the current non-initial access request.

2. The method according to claim 1, wherein the method further comprises:
when the current non-initial access request carries the session control identifier and carries the auxiliary authentication data, judging whether an API called by the current non-initial access request is consistent with a preset trap API; and
when the API called by the current non-initial access request is consistent with the preset trap API, capturing the current non-initial access request.

3. The method according to claim 1, wherein the method further comprises:
when the current non-initial access request carries the session control identifier and carries the auxiliary authentication data, judging whether the time corresponding to a time stamp carried by the current non-initial access request has been shifted previously; and
when the time has been shifted previously, capturing the current non-initial access request.

4. The method according to claim 1, wherein the method further comprises:
when the current non-initial access request carries the session control identifier and carries the auxiliary authentication data, judging whether request data carried by the current non-initial access request is consistent with preset trap data; and
when the request data carried by the current non-initial access request is consistent with the preset trap data, capturing the current non-initial access request.

5. The method according to claim 1, wherein the method further comprises:
when the current non-initial access request carries the session control identifier and carries the auxiliary authentication data, judging whether the current non-initial access request instructs to call an authentication interface of a preset false database; and
when the current non-initial access request instructs to call the authentication interface of the preset false database, capturing the current non-initial access request.

6. The method according to claim 1, wherein the method further comprises:
when the current non-initial access request carries the session control identifier and carries the auxiliary authentication data, executing the following judgment steps according to a preset order of execution:
judging whether an API called by the current non-initial access request is consistent with a preset trap API,
judging whether the time corresponding to a time stamp carried by the current non-initial access request has been shifted previously,
judging whether request data carried by the current non-initial access request is consistent with preset trap data, and
judging whether the current non-initial access request instructs to call an authentication interface of a preset false database;
when the result of any one of the above judgment steps is yes, stopping executing the subsequent judgment steps, and capturing the current non-initial access request; and
when capturing the current non-initial access request, executing a malicious request handling operation.

7. The method according to claim 6, the step of executing a malicious request handling operation comprises:
determining a malicious access level corresponding to the current non-initial access request, and updating malicious access data corresponding to the current user, wherein the malicious access data is used for recording numbers of malicious access attempts corresponding to different malicious access levels; and
when the number of malicious access attempts corresponding to any one of the malicious access levels reaches a corresponding preset threshold value, executing an access restriction operation.

8. (canceled)

9. A computer device, wherein the computer device comprises a memory and one or more processors, the memory has computer-readable instructions stored therein, and the computer-readable instructions, when executed by the one or more processors, cause the one or more processors to execute steps of an access request capturing method, wherein the steps comprise:
upon receiving an initial access request from a current user, returning session response information, wherein the session response information comprises a session control identifier and auxiliary authentication data that are stored at different locations;
receiving a current non-initial access request from the current user; and
when the current non-initial access request carries the session control identifier and does not carry the auxiliary authentication data, capturing the current non-initial access request.

10. A non-transitory computer-readable storage media,
having computer-readable instructions stored therein, wherein the computer-readable instructions, when executed by one or more processors, cause the one or more processors to execute steps of an access request capturing method, wherein the steps comprise:
upon receiving an initial access request from a current user, returning session response information, wherein the session response information comprises a session control identifier and auxiliary authentication data that are stored at different locations;
receiving a current non-initial access request from the current user; and
when the current non-initial access request carries the session control identifier and does not carry the auxiliary authentication data, capturing the current non-initial access request.

11. The method according to claim 1, wherein the auxiliary authentication data is set at different locations in a response header of the session response information.

12. The method according to claim 1, wherein the auxiliary authentication data is field values of a plurality of fields.

13. The method according to claim 1, wherein the auxiliary authentication data is a character with a specified number of digits in a field value of one field.

14. The method according to claim 1, wherein the non-initial access request comprises: an access request for requesting the access to website resources, requesting the change of resource attributes or requesting the change of permissions that is received after the initial access request.

15. The method according to claim 2, wherein the method further comprises: calling a core API in a hidden manner and setting a trap API by using the Representational State Transfer (REST) technology.

16. The method according to claim 4, wherein the step of judging whether request data carried by the current non-initial access request is consistent with preset trap data comprises:
judging whether a username in the request data is consistent with a username in the preset trap data.

17. The method according to claim 16, wherein the step of judging whether request data carried by the current non-initial access request is consistent with preset trap data further comprises:
judging whether a character at another location in the request data is consistent with a preset character in the trap data.

18. The method according to claim 7, wherein the malicious access levels comprise:
a first-level of malicious access request: the time corresponding to a time stamp carried by the current non-initial access request has been shifted previously;
a second-level of malicious access request: an API called by the current non-initial access request is consistent with a preset trap API, or request data carried by the current non-initial access request is consistent with preset trap data, or the current non-initial access request instructs to call an authentication interface of a preset false database; and
a third-level of malicious access request: the current non-initial access request carries a session control identifier and does not carry auxiliary authentication data.

19. The computer device according to claim 9, wherein the steps further comprise:
when the current non-initial access request carries the session control identifier and carries the auxiliary authentication data, judging whether an API called by the current non-initial access request is consistent with a preset trap API; and
when the API called by the current non-initial access request is consistent with the preset trap API, capturing the current non-initial access request.

20. The computer device according to claim 9, wherein the steps further comprise:
when the current non-initial access request carries the session control identifier and carries the auxiliary authentication data, judging whether the time corresponding to a time stamp carried by the current non-initial access request has been shifted previously; and
when the time has been shifted previously, capturing the current non-initial access request.

21. The non-transitory computer-readable storage media according to claim 10, wherein the steps further comprise:
when the current non-initial access request carries the session control identifier and carries the auxiliary authentication data, judging whether an API called by the current non-initial access request is consistent with a preset trap API; and
when the API called by the current non-initial access request is consistent with the preset trap API, capturing the current non-initial access request.
